(19) United States
(12) Patent Application Publication
(10) Pub. No.: US 2026/0228591 A1
(43) Pub. Date: Aug. 6, 2026

(54) TRAINING QUANTUM GENERATIVE NETWORKS BASED ON MARGINAL AND JOINT DISTRIBUTIONS

(71) Applicant: Fujitsu Limited, Kawasaki-shi, Kanagawa (JP)

(72) Inventors: Hannes LEIPOLD, San Francisco, CA (US); Bibhas ADHIKARI, San Jose, CA (US); Sharan Mouyra BATHALA, Champaign, IL (US)

(73) Assignee: Fujitsu Limited, Kawasaki-shi, Kanagawa (JP)

(21) Appl. No.: 19/042,723

(22) Filed: Jan. 31, 2025

(51) Int. Cl. G06N 10/60; G06N 10/20

(52) U.S. Cl. CPC G06N 10/60; G06N 10/20

(57) ABSTRACT

In an embodiment, a parameterized quantum circuit is initialized on a quantum computer for a Quantum Neural Network (QNN) with trainable parameters to learn a first conditional distribution of a training dataset. A marginal distribution is loaded on a first set of qubits and the first joint distribution on a second set of qubits. The QNN is operated on the marginal distribution to predict the first conditional distribution. The QNN is operated on the marginal distribution and first conditional distribution to generate a second conditional distribution for the input data and second output data. A second joint distribution is generated from the second conditional distribution and loaded onto a third set of qubits. Joint quantum measurements are extracted from the second and first joint distributions to train the QNN to learn the first conditional distribution.

### FIELD

The embodiments discussed in the present disclosure are related to training quantum generative networks based on marginal and joint distributions.

### BACKGROUND

Quantum computing leverages quantum bits, or qubits, which exist in multiple states simultaneously due to superposition and entanglement. The multiple states enable quantum computers to perform complex calculations much faster than traditional binary computers, which use bits that are either “0” or “1”. However, the quantum computing faces several challenges, particularly, in integrating classical memory systems for operation control. Current quantum computers, such as, Noisy Intermediate-Scale Quantum (NISQ) devices, face challenges like limited qubit counts, high error rates, and difficulty in maintaining qubit states. The quantum computers rely on classical computers for error correction, but classical systems struggle with complexity. Integration issues and physical limitations of qubits further impact performance and scalability. Further, there may be limited control in case of digital quantum computers with parameterized quantum circuits, where parameters may be stored on a classical device. This may be because classical control is limited over exponential representation spaces of quantum wavefunctions. The above limitation may be required to be overcome to effectively utilize digital quantum computers with classical memory controlling operations.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of the disclosure, operations may include initializing, on a quantum computer, a parameterized quantum circuit that implements a Quantum Neural Network (QNN) with trainable parameters to learn a first conditional distribution of a training dataset comprising input data and a first output data. The operations may further include loading a marginal distribution associated with the input data on a first set of qubits of a first set of registers of the quantum computer. The operations may further include operating the QNN on the marginal distribution to predict the first conditional distribution based on the input data and the first output. The operations may further include loading a first joint distribution associated with the input data and the first output data on a second set of qubits of a second set of registers of the quantum computer. The operations may further include operating the QNN on the marginal distribution associated with the input data and the first conditional distribution to generate a second conditional distribution associated with the input data and second output data. The operations may further include generating a second joint distribution based on the second conditional distribution. The operations may further include loading the second joint distribution on a third set of qubits of a third set of registers of the quantum computer. The operations may further include extracting joint quantum measurements over the second joint distribution loaded on the third set of qubits of the third set of registers and the first joint distribution loaded of the second set of qubits of the second set of registers. The operations may further include training the QNN based on the joint quantum measurements to configure the QNN to learn the first conditional distribution.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram representing an exemplary computing environment for training quantum generative networks based on marginal and joint distributions;

FIG. 2 is a block diagram of a system for training quantum generative networks based on marginal and joint distributions;

FIG. 3 is a flowchart of an example method for training with distribution loading;

FIG. 4 is a diagram that illustrates exemplary circuit implementation for training quantum generative networks based on marginal and joint distributions;

FIG. 5 is a diagram that illustrates exemplary circuit for an explicit SWAP test;

FIG. 6 is a diagram that illustrates exemplary circuit for distribution loading;

FIGS. 7A-7F are schematic diagrams of layered circuits structures for a quantum neural network (QNN); and

FIG. 8 is a flowchart of an example method for training quantum generative networks based on marginal and joint distributions,

all according to at least one embodiment described in the present disclosure.

### DESCRIPTION OF EMBODIMENTS

Embodiments of the present disclosure are explained with reference to the accompanying drawings. Some embodiments described in the present disclosure may relate to methods and electronic devices for training quantum generative networks based on marginal and joint distributions. In the present disclosure, on a quantum computer, a parameterized quantum circuit that implements a Quantum Neural Network (QNN) with trainable parameters may be initialized. The QNN may be configured to learn a first conditional distribution of a training dataset comprising input data and a first output data. A marginal distribution associated with the input data may be loaded on a first set of qubits of a first set of registers of the quantum computer. The QNN may be operated on the marginal distribution to predict the first conditional distribution based on the input data and the first output. A first joint distribution associated with the input data and the first output data may be loaded on a second set of qubits of a second set of registers of the quantum computer. The QNN may be operated on the marginal distribution associated with the input data and the first conditional distribution to generate a second conditional distribution associated with the input data and second output data. A second joint distribution may be generated based on the second conditional distribution. The second joint distribution may be loaded on a third set of qubits of a third set of registers of the quantum computer. Joint quantum measurements may be extracted over the second joint distribution loaded on the third set of qubits of the third set of registers and the first joint distribution loaded of the second set of qubits of the second set of registers. The QNN may be trained based on the joint quantum measurements to configure the QNN to learn the first conditional distribution.

Quantum computing holds a great promise for a variety of applications, which has fueled a quest to develop the necessary physical hardware. Quantum algorithms, for example, may factor numbers, simulate quantum systems, or solve linear systems of equations with an exponential speedup over classical methods. Due to the extremely high computational cost, applications such as, simulating complex quantum systems or solving large-scale linear algebra problems may be extremely difficult for classical computers. Although fault-tolerant quantum computers may unlikely be available in the near future, quantum computers, especially gate-based quantum computers do promise a solution. Current quantum devices have significant limitations, such as a limited number of qubits and noise processes that limit circuit depth.

Hybrid quantum-classical algorithms, such as Quantum Approximate Optimization Algorithm (QAOA) may be seen as a promising candidate for demonstrating quantum advantage in optimization on near-term quantum computers. QAOA is typically used for obtaining approximate solutions of combinatorial optimization problems, such as, graph-based optimizations. At each call to the quantum computer, a trial state may be prepared by applying a sequence of pairs of alternating quantum operators. The two alternating operators may be referred to as a phase operator (which encodes the objective function of the combinatorial optimization problem), and a mixing operator.

Further, training of Quantum Neural Networks (QNNs) on digital quantum computers may significantly be challenging, as training may involve many iterations due to slow convergence to optimal states. Further, despite many iterations the training may involve poor convergence to optimal states. Generally, the training process of QNNs does not have direct analogues from classical neural network training such as, back propagation. Furthermore, due to the properties of quantum measurements, the training involves learning from samples after the wavefunction collapses to classical states. Further, there may be limited control in case of digital quantum computers with parameterized quantum circuits, where parameters may be stored on a classical device. This may be because classical control is limited over exponential representation spaces of quantum wavefunctions. Due to the fundamental limitation, the utilization of the digital quantum computers may involve classical memory controlling operations.

Typically, the digital quantum computers may have quantum digital representations (qubits and qudits) that are similar to the role of bits and digits in modern classical computers. The digital quantum computers may include circuits that may be defined by running a collection of gates over a qubit register. Here, the gates may be defined as controlled electromagnetic pulse sequences. Further, the gates may be unitary transformations that change a state, such as, an amplitude and a phase of the waveform. Further, the gates may be parameterized, and the pulses may be controlled by electric signals stored in a memory bank similar to working memory, cache, and RAM in classical computers. The major problem arises from the limitations of classical control over digital quantum systems, leading to challenges in the training of parameters to control the system.

The technological field of training of QNNs or quantum generative networks may be improved by configuring an electronic device to use marginal and joint distributions for training. The electronic device may implement, on a quantum computer, a parameterized quantum circuit that implements a Quantum Neural Network (QNN) with trainable parameters may be initialized. The QNN may be configured to learn a first conditional distribution of a training dataset comprising input data and a first output data. The electronic device may load a marginal distribution associated with the input data may be loaded on a first set of qubits of a first set of registers of the quantum computer. The electronic device may operate the QNN on the marginal distribution to predict the first conditional distribution based on the input data and the first output. The electronic device may load a first joint distribution associated with the input data and the first output data on a second set of qubits of a second set of registers of the quantum computer. The electronic device may operate the QNN on the marginal distribution associated with the input data and the first conditional distribution to generate a second conditional distribution associated with the input data and second output data. The electronic device may generate a second joint distribution may be based on the second conditional distribution. The electronic device may load the second joint distribution on a third set of qubits of a third set of registers of the quantum computer. Thereafter, the electronic device may extract joint quantum measurements over the second joint distribution loaded on the third set of qubits of the third set of registers and the first joint distribution loaded of the second set of qubits of the second set of registers. The electronic device may train the QNN based on the joint quantum measurements to configure the QNN to learn the first conditional distribution.

The present disclosure may address typical problems of QNN training by providing a solution to exploit quantum phenomenon in many-body systems that allow for global information extraction and accelerate the learning process and improve optimality of parameters. The present disclosure may prepare specific quantum states in parallel across different qubit registers. The quantum measurements may be taken after applying the Quantum Neural Network (QNN), and further may be utilized to update parameters using information stored on ancilla qubits. The system's ability to perform a cross-register measurements and application of control gates from ancillary qubit registers to other registers may be leveraged to enhance the method. The method may optimize the use of quantum resources and improve the efficiency of quantum computations.

The method described in the disclosure may use a wavefunction cross fidelity measures to train the QNN, instead of relying on a classical loss computed from classical samples post wavefunction collapse. The method may enhance a convergence quality by providing a high-quality measure over all data points at each measurement, rather than focusing on a single data point. Additionally, the method may draw parallels to the use of Bhattacharyya loss in a classical NNs, suggesting a more efficient and accurate training process for the QNN. Further, the method may eliminate the need for a Nash equilibrium training procedure, commonly used in quantum Generative Adversarial Networks (qGANs). The method disclosed in the present disclosure utilizes the entire marginal distributions and the joint distributions, thus resulting in a stable and faster training process, further significantly accelerating learning process of the QNN, and improving the accuracy.

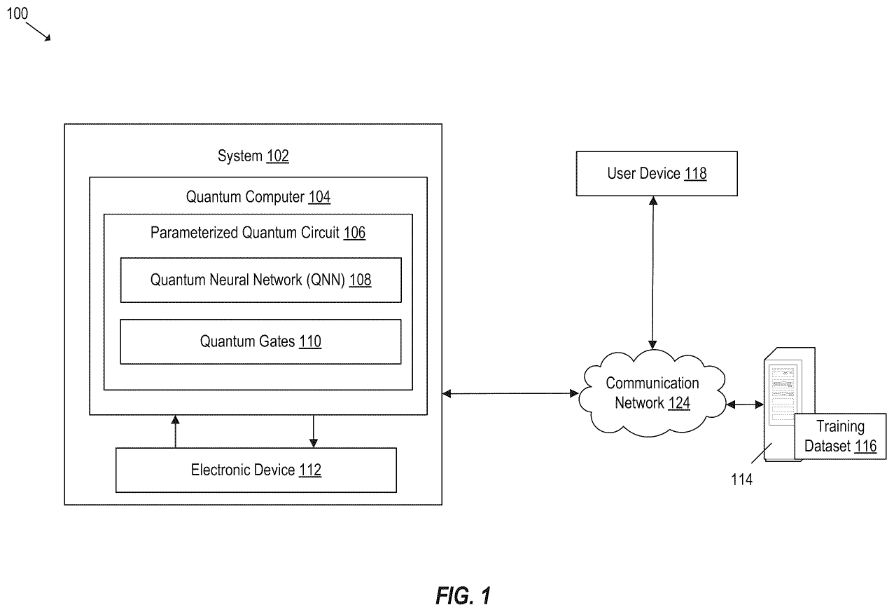

FIG. 1 is a diagram representing an exemplary computing environment for training quantum generative networks based on marginal and joint distributions, according to at least one embodiment described in the present disclosure. With reference to FIG. 1, there is shown a computing environment 100. The computing environment 100 includes a system 102, a user device 118, a host terminal 114 storing a training dataset 116, and a communication network 120. The system 102 includes a quantum computer 104 and an electronic device 112. As further shown, a parameterized quantum circuit 106 may be implemented on the quantum computer 104 and further a quantum neural network (QNN) 108 and quantum gates 110 may be implemented on the parameterized quantum circuit 106. In certain embodiments, the system 102 may be referred to as a trainer that trains quantum generative networks based on marginal and joint distributions. The system 102, the host terminal 114, and the user device 118 may be communicatively coupled to each other, via the communication network 120.

The system 102 may be a part of an on-premises computing environment or a cloud computing environment. The system 102 may include suitable logic, circuitry, and interfaces that may be configured to execute operations associated with hybrid quantum-classical algorithms such as the Quantum Approximate Optimization Algorithm (QAOA) for solving combinatorial optimization problems. QAOA algorithm may be suitable for solving real-world optimization problems using resources of the quantum computer 104 and a classical computer (i.e., the electronic device 112). The real-world optimization problem may be any optimization problem that can be training of the QNN 108 on digital quantum computers such as the system 102. For example, the real-world optimization problem involves many training iterations due to slow convergence to optimal states. Further, despite numerous iterations the convergence of optimal states remains poor. Further, absence of direct analogues such as backpropagation when compared with the classical neural network training, and the closest analogues that may be present are slow and require many samples. As per the properties of quantum measurements, the training involves learning from samples after quantum wavefunctions collapses to classical states.

Furthermore, the real-world optimization problem may involve a limited control in the digital quantum computers with the parameterized quantum circuit 106, where the trainable parameters for learning may be stored on a classical device. The classical control may be limited over the exponential representation spaces of the quantum wavefunctions. These limitations must be overcome to utilize the quantum computer 104 with classical memory controlling operations. Examples of the real-world optimization problem may include, but are not limited to, Ising model of spin glasses, problem of modularity maximization, VLSI circuit design (e.g., via minimization problem), data clustering problem, determination of maximum balanced subgraph in a signed graph, or maximum-2-Sat problem.

The quantum computer 104 may be a gate-based quantum computer that may be configured to receive an input and transform the input in accordance with a unitary operation (that may be defined as a sequence of quantum logic gate operations and measurements). The operation may be represented by the parameterized quantum circuit 106.

In one or more embodiments of the disclosure, the quantum computer 104 may be implemented as a generalized quantum computing device that may be hosted on a cloud optimization system. The cloud optimization system may be implemented as one of a private cloud, a public cloud, or a hybrid cloud. In such an implementation, the generalized quantum computing device may use specialized optimization solving software applications or simulation software at an application layer to implement hybrid quantum algorithms such as QAOA to search for a solution of an optimization problem from a discrete solution space.

The generalized quantum computing device may be different from a digital bit-based computing device, such as, digital devices that are based on transistor-based digital circuits. The generalized quantum computing device may include one or more of the quantum gates 110 that use quantum bits (hereinafter referred to as “qubits”) to perform computations for different information processing applications, such as, QAOA computations for vias minimization in VLSI design. In general, a qubit can represent “0”, “1”, or a superposition of both “0” and “1”. In most cases, the generalized quantum computing device may need a carefully controlled cryogenic environment to function properly. The generalized quantum computing device may use certain properties found in quantum mechanical systems, such as, quantum fluctuations, quantum superposition of its Eigenstates, quantum tunneling, and quantum entanglement. These properties may help the generalized quantum computing device to perform computations for solving certain mathematical problems (e.g., graph-based optimizations using QAOA circuits) to exhibit quantum advantage. Typically, these problems may be computationally intractable for conventional computing devices (e.g., classical computers that use transistor-based circuits). Examples of the generalized quantum computing device may include, but are not limited to, a silicon-based nuclear spin quantum computer, a trapped ion quantum computer, a cavity quantum-electrodynamics (QED) computer, a quantum computer based on nuclear spins, a quantum computer based on electron spins in quantum dots, a superconducting quantum computer that uses superconducting loops and Josephson junctions, and a nuclear magnetic resonance quantum computer.

In some other embodiments, the quantum computer 104 may be a special-purpose quantum computer that may be designed, and hardware/software optimized to implement QAOA or meta-heuristic algorithms, such as, quantum annealing. Similar to a generalized quantum computing device, the special-purpose quantum computer may use qubits and may require a carefully controlled cryogenic environment to function properly.

In some other embodiments, the quantum computer 104 may be a digital quantum-computing processor for training quantum generative networks based on marginal and joint distributions using QAOA. More specifically, the quantum computer 104 may be implemented as a quantum simulation software that may be executable on a digital computer with a semiconductor-based processor. The quantum simulation software may be designed to model the functionality of the quantum computer 104 on digital circuitry. The digital computer may operate at room temperature and may not require a cryogenic environment to function.

In some other embodiments, the quantum computer 104 may include a processor to execute software instructions such as subroutines for the parameterized quantum circuit 106. Example implementations of the processor may include, but are not limited to, a Reduced Instruction Set Computing (RISC) processor, an Application-Specific Integrated Circuit (ASIC) processor, a Complex Instruction Set Computing (CISC) processor, a Graphical Processing Unit (GPU), a Co-processor, and/or a combination thereof. In an embodiment, the quantum computer 104 may correspond to at least one of, but not limited to, quantum processors, digital quantum computers, quantum computers based on microwave-pulses acting on superconducting devices, or quantum computers based on laser pulses acting on ion-trap devices.

The parameterized quantum circuit 106 may correspond to a computational routine (i.e., a set of instructions) that combines coherent quantum operations on quantum data, such as qubits with real-time classical computations. The parameterized quantum circuit 106 may include an ordered series of the quantum gates 110, measurements, and resets that may be all be conditioned on real-time classical computation and may use data gathered from classical computation. In accordance with an embodiment, the parameterized quantum circuit 106 may be a QAOA circuit that includes a set of the quantum gates 110 for operators (e.g., phase and mixing operators) and a set of qubits (e.g., logical qubits that represent physical qubits) on which the operators and the quantum gates 110 may be configured to operate. For QAOA, the quantum gates 110 may include, for example, one or more Hadamard gates, Rx and Rz gates (i.e., Rotation Operators), and a CNOT gate. The ansatz (and the parameterized quantum circuit 106) may vary depending on the training dataset 116.

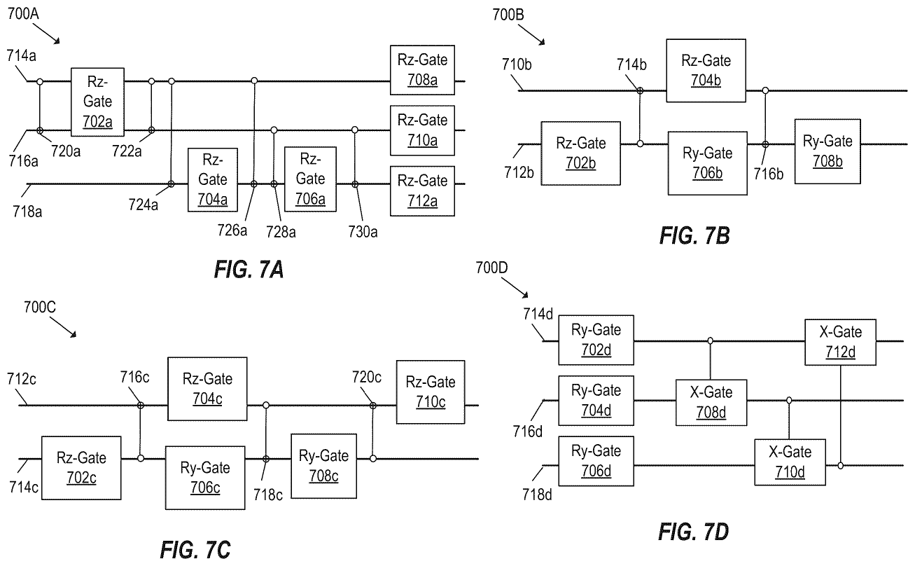

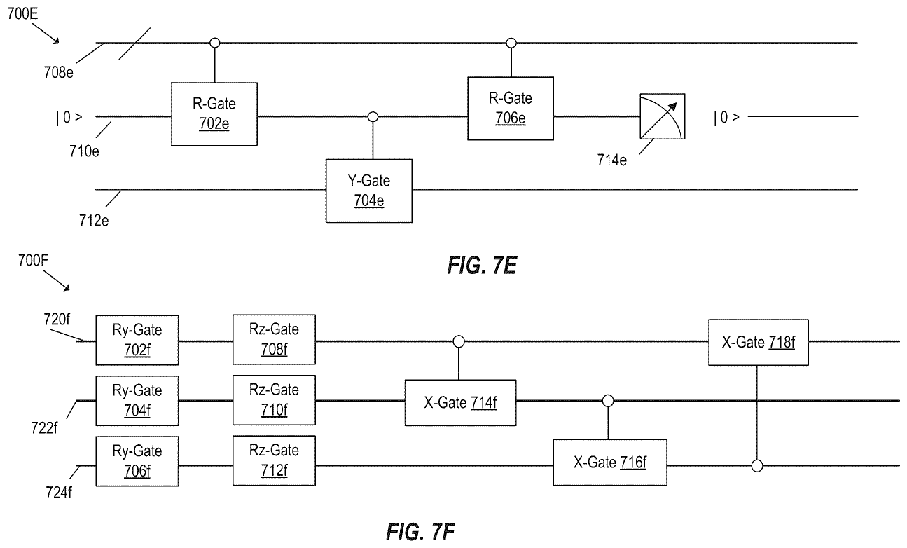

In accordance with an embodiment, the parameterized quantum circuit 106 may include one or more neural networks (NNs) layers such as the QAOA-like layer (as shown in FIG. 7A), a pooling layer (as shown in FIG. 7B), a convolutional layer (as shown in FIG. 7C), a real amplitude layer (as shown in FIG. 7D), a quantum neuron layer (as shown in FIG. 7E), an efficient SU2 layer (as shown in 7F), and the like.

The QNN 108 (for example, a Variational Quantum Classifier (VQC)) may correspond to a computational routine (i.e., a set of instructions) that combines coherent quantum operations on quantum data, such as qubits with real-time classical computations. The VQC may include an ordered series of the quantum gates 110, measurements, and resets that may be all be conditioned on real-time classical computation and may use data gathered from classical computation. In accordance with an embodiment, the VQC may be the parameterized quantum circuit 106 that includes a set of the quantum gates 110 for operators (e.g., phase and mixing operators) and a set of qubits (e.g., logical qubits that represent physical qubits) on which the operators and the quantum gates 110 may be configured to operate. The ansatz may vary depending on the training dataset 116 that may be used to train the QNN 108.

In an embodiment, the quantum computer 104 may be a gate-based quantum computer that may be configured to receive an input and transform the input in accordance with a unitary operation (that may be defined as a sequence of quantum gate operations and measurements).

The quantum gates 110 may be the basic building blocks of quantum circuits or the quantum computer 104 that may be used to manipulate the quantum state of qubits. The quantum gates 110 may be a mathematical operation that acts on the state of one or more qubits and may be represented by a matrix. The quantum gates 110 may leverage key aspects of quantum mechanics, such as, superposition and entanglement, to perform operations that are not possible with classical gates. The quantum gates 110 may be unitary operators described as unitary matrices relative to some orthonormal basis. In an embodiment, the quantum gates 110 may include, for example, one or more Hadamard gates, Rx and Rz gates (i.e., Rotation Operators), and a CNOT gate, Pauli gates (X, Y, Z), and a T gate. The quantum gates 110 may be essential for performing quantum algorithms and are analogous to classical logic gates in conventional digital circuits. The quantum gates 110 may use quantum bits (hereinafter referred to as “qubits”) to perform computations for different information processing applications. In general, a qubit can represent “0”, “1”, or a superposition of both “0” and “1”. In most cases, the generalized quantum computing device may need a carefully controlled cryogenic environment to function properly.

The electronic device 112 may include suitable logic, circuitry, and interfaces that may be configured to execute program instructions associated with a digital computer configured to train the QNN 108. The electronic device 112 may be a classical computer (i.e., a transistor-based computer with semiconductor-based digital circuitry) that operates in tandem or in conjunction with the quantum computer 104 to train the QNN 108 to perform machine learning tasks. In an embodiment, the electronic device 112 may operate in tandem or in conjunction with the quantum computer 104 to solve optimization problems.

The host terminal 114 may include suitable logic, circuitry, and interfaces that may be configured to display a User Interface (UI) with option(s) to configure and submit a real-world optimization problem. The host terminal 114 may communicate with the system 102 via a network interface, over the communication network 120. Examples of the host terminal 114 may include, but are not limited to, a mobile device, a desktop computer, a laptop, a virtual machine, a computer workstation, or a server such as a cloud server. The host terminal 114 may maintain the training dataset 116 to learn a first conditional distribution.

The training dataset 116 comprises input data and a first output data to learn a first conditional distribution. The training dataset 116 may be stored in a database (not shown in FIG. 1) on the host terminal 114. The database may include suitable logic, circuitry, interfaces, and/or code that may be configured to store the training dataset 116. The database may be derived from data off a relational or non-relational database, or a set of comma-separated values (csv) files in a conventional storage or a big-data storage. The database may be stored or cached on a device, such as, the host terminal 114 or the electronic device 112. The device storing the database may be configured to receive a query for the training dataset 116. In response, the device storing the database may be configured to retrieve and transmit the training dataset 116 to the host terminal 114 and/or electronic device 112.

In accordance with an embodiment, the database may be hosted on a plurality of servers stored at same or different locations. The operations of the database may be executed using hardware including a processor, a microprocessor (for example, to perform or control performance of one or more operations), a field-programmable gate array (FPGA), or an application-specific integrated circuit (ASIC). In some other instances, the database may be implemented using software. A person with ordinary skill in the art will understand that the scope of the disclosure may not be limited to the implementation of the database and the host terminal 114 (or the electronic device 112) as two separate entities. In certain embodiments, the functionalities of the database can be incorporated in its entirety or at least partially in the host terminal 114 (or the electronic device 112), without a departure from the scope of the disclosure.

The user device 118 may include suitable logic, circuitry, and interfaces that may be configured to render a User Interface (UI) with option(s) to configure and submit a dataset (i.e., input data points and labels corresponding to the input data points) that may be associated with training of the QNN 108. The UI may further render parameters of the QNN 108, and a cost function value associated with the QNN 108, which may be determined at each time-step. The user device 118 may communicate with the system 102, via a network interface, over the communication network 120. Examples of the user device 118 may include, but are not limited to, a mobile device, a desktop computer, a laptop, a virtual machine, a computer workstation, or a server such as a cloud server.

The communication network 120 may include a communication medium through which the system 102, the host terminal 114, and the user device 118 may communicate with each other. The communication network 120 may be one of a wired connection or a wireless connection. Examples of the communication network 120 may include, but are not limited to, the Internet, a cloud network, Cellular or Wireless Mobile Network (such as Long-Term Evolution and 5G New Radio), a satellite network (such as, a network of a set of low-earth orbit satellites), a Wireless Fidelity (Wi-Fi) network, a Personal Area Network (PAN), a Local Area Network (LAN), or a Metropolitan Area Network (MAN). Various devices in the computing environment 100 may be configured to connect to the communication network 120 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

In operation, the system 102 may initialize the parameterized quantum circuit 106 on the quantum computer 104. The parameterized quantum circuit 106 may implement the QNN 108 with trainable parameters to learn a first conditional distribution of the training dataset 116 comprising an input data and a first output data. In an embodiment, the trainable parameters may be the tunable parameters or weights within the parameterized quantum circuit 106. The trainable parameters may be adjusted during the training process to optimize the performance of the QNN 108. For example, the trainable parameters may be denoted as θ[0], . . . , θ[15] in the VQC.

The first conditional distribution may refer to the probability distribution of a state of the quantum computer 104 (associated with the system 102). The state may be associated with certain conditions or measurements associated with the quantum computer 104. The first conditional distribution may be crucial for understanding state evolution and interaction based on the training dataset 116. The input data in the training dataset 116 may be loaded on one of set qubit registers. The first output data in the training dataset 116 may be the data that has been obtained by processing the input data. For example, the first conditional distribution may be determined for two domains, x in X and y in Y, p(x,y). The system 102 may represent p(x|y), such that given a specific yᵢₙₚᵤₜ, the system 102 may generate p(x|yᵢₙₚᵤₜ). Further, the first output data in the training dataset 116 may be given as a sample from the first conditional distribution. In another exemplary embodiment, the first conditional distribution may be described as the probability of an event occurring given that another event has already occurred. For a random variable X conditioned on another variable Y, the first conditional distribution may be p(X|Y). In quantum mechanics, the state of a quantum system may be described by a wave function or density matrix. Furthermore, the changes in the state of the system 102 may be based on certain measurements made or specific conditions.

After initializing the parameterized quantum circuit 106, the system 102 may load a marginal distribution associated with the input data on a first set of qubits of a first set of registers of the quantum computer 104. For example, the marginal distribution associated with the input data may be loaded on qubit registers “1” to “n”. As used herein, the term “marginal distribution” may refer to a probability distribution of a subset of dataset from a larger dataset, focusing on the dataset while ignoring others. The marginal distribution allows analysis of behavior of each datapoint of dataset independently from the influence of parameters in the dataset. In context with the disclosure, the marginal distributions may serve as a bridge between classical probability theories and the quantum counterparts. The marginal distribution may enable analyses in complex systems, such as, the QNN 108. The marginal distribution may simplify computations and determine interdependencies of each datapoint of the dataset within the system 102 (associated with the quantum computer 104).

The system 102 may operate the QNN 108 on the marginal distribution to predict the first conditional distribution based on the input data and the first output. For an exemplary embodiment, the parameterized quantum circuit 106 with the trainable parameters may be applied on the system 102. The parameterized quantum circuit 106 may learn the first conditional distribution of the training dataset 116 between the input data and the output data. Further, for example the first conditional distribution may be predicted on qubit registers (such as, “n+1” to “n+m”) based on the input data (or a marginal distribution) loaded on the first set of qubits of the first set of registers of the quantum computer 104.

The system 102 may load a first joint distribution associated with the input data and the first output data on a second set of qubits of a second set of registers of the quantum computer 104. For example, the first joint distribution may be loaded on the qubit registers, such as, “n+m+1” to “2(n+m)”. In an embodiment, the first joint distribution may be an actual joint distribution associated with the input data and the first output data. As used herein, the term “joint distribution” refers to a statistical measure that may provide the probability of two or more random variables associated with a dataset occurring simultaneously. In mathematical terms, for discrete random variables X₁, X₂, . . . , X_{K}, the joint distribution may assign a probability to each combination of outcomes: P (X₁=x₁, X₂=x₂, . . . , X_{K}=x_{K}). In context of the present disclosure, the first joint distribution refers to the probability distribution that characterizes the simultaneous behavior of multiple quantum variables (such as training dataset 116) or states. Thus, based on the first joint distribution, the system 102 may learn to predict from complex quantum dataset.

The system 102 may operate the QNN 108 on the marginal distribution associated with the input data and the first conditional distribution to generate a second conditional distribution associated with the input data and second output data. Further, the system 102 may generate a second joint distribution based on the second conditional distribution. For example, the QNN 108 may be used on the first “n+m” qubits of the set of registers to generate the second joint distribution by the second conditional distribution on “n+1” to “n+m” qubits. By doing so, the system 102 may be said to describe the second joint distribution on a third set of qubits of a third set of registers of the quantum computer 104. For example, the second joint distribution may be loaded on “1” to “n+m” qubits (as the second joint distribution may be associated with the first marginal distribution and the second conditional distribution, thus the second joint distribution may be overwritten on the “1” to “n+m” qubits, i.e., the third set of qubits of the third set of registers).

For measuring overlap between the first joint distribution and the second joint distribution, the system 102 may extract joint quantum measurements over the second joint distribution loaded on the third set of qubits of the third set of registers and the first joint distribution loaded of the second set of qubits of the second set of registers. As used herein, the term “joint quantum measurements” refers to the method of measuring multiple quantum systems (such as, the system 102 or the quantum computer 104) simultaneously. The outcomes of joint quantum measurements may be interdependent. The joint quantum measurements may allow exploration of correlations between different quantum states, which may be essential for various applications, such as, a quantum communication, entanglement studies, and a superdense coding. In context of the present disclosure, the joint quantum measurements may be associated with unitary measurements and cross-qubit measurements.

Further, the joint quantum measurements may be associated with a fourth set of qubits (such as, “ancilla qubits”) of a fourth set of registers of the quantum computer 104. As used herein, the term “ancilla qubits” refers to extra qubits used in the quantum computer 104 to facilitate computations without being part of the main data processing. The ancilla qubits may be initialized in a known state, often “|0)”, where the final state may not be critical to the output of the computation. Instead, the ancilla qubits may help implementation of the quantum gates 110 and perform operations on other qubits. In context of the present disclosure, the ancilla qubits may be used for storing the joint quantum measurements. Further, the ancilla qubits may assist a designing of the QNN 108. For example, the ancilla qubits may be loaded on registers “2(n+m)+1” to “2(n+m)+a”, where there may be “a” ancilla qubits.

As used herein, the term “positive operator-valued measurements” refers to an application of unitary or Kraus operators to quantum states followed by a measurement over a subset of qubits. The application of unitary operators enables evolution of quantum states through reversible transformations that may further allow probabilistic outputs upon the subsequent measurements. In the context of open quantum systems, which include controlled or uncontrolled quantum environments, unitary operators may be a type of Kraus operator which may be reversible. Kraus operators can also be considered operators in which unitary interactions and measurements with the surrounding quantum environment are not neglected. However, the quantum system can only be controlled to recognize effects on the quantum system and some part of its quantum environment. For example, in the presence of noise, unitary operators are an idealization of the actual operation of the quantum system based on there being limited unitary operations between the system and its environment such that the quantum system is sufficiently isolated to evolve according to unitary dynamics only specified on the system itself up to acceptable error tolerance.

In embodiment, the cross-qubit measurements may be based on qubits on different registers of the quantum computer 104. Further, the joint quantum measurements may be applied over a set of qubits of a set of registers. The set of qubits of the set of registers may include the first set of qubits of the first set of registers, the second set of qubits of the second set of registers, the third set of qubits of the third set of registers, the fourth set of qubits of the fourth set of registers, and the ancilla qubits (overall qubits from “1” to “2(n+m)+a”).

In an embodiment, the first set of qubits of the first set of registers may be concatenated with the third set of qubits of the third set of registers to obtain a fifth set of qubits stored on the first set of registers and third set of registers. Further, the cross-qubit measurements may be performed between the fifth set of qubits on the first set of registers and third set of registers (such as, “1” to “n+m”), and the second set of qubits of the second set of registers (such as, “n+m+1” to “2(n+m)”). Thus, the cross-qubit measurements may be performed between the first joint distributions and second joint distributions to measure an overlap.

The system 102 may train the QNN 108 based on the joint quantum measurements to configure the QNN 108 to learn the first conditional distribution. The cross-qubit measurements may guide the training process. In an embodiment, the training of the QNN 108 may be based on multi-qubit measurements.

Upon the training of the QNN 108, the system 102 may perform a swap test. As used herein, the term “swap test” refers to a test that determines the similarity or overlap between two quantum states. In context of the present disclosure, the swap test may be based on a utilization of a series of the quantum gates 110 to measure the overlap between two quantum states, wherein, the two quantum states may be denoted as “|ψ₁ [symbol] ”, and “|ψ₂ [symbol] ”.

In an embodiment, for swap testing, the system 102 may determine a first fidelity loss between the first joint distribution and the second joint distribution. As used herein, the term “fidelity loss” refers to degradation of the accuracy and reliability of any state or operations due to various sources of error. The fidelity loss determines an integrity of information. In context of the present disclosure, the fidelity loss may be calculated to determine the overlap or similarity between the first joint distribution and the second joint distribution. Further, the system 102 may generate an ancilla qubit “a” in a state using at least one quantum gate of the quantum gates 110.

In an embodiment, the system 102 may swap the second set of qubits with the fifth set of qubits based on the state of the ancilla qubit and then may operate the QNN 108 on the marginal distribution associated with the input data to generate a third conditional distribution associated with the second set of qubits and third output data. Further, the system 102 may generate a third joint distribution based on the third conditional distribution and operate the QNN 108 on the marginal distribution associated with the input data to generate a fourth conditional distribution associated with the fifth set of qubits and fourth output data. Further, the system 102 may generate a fourth joint distribution based on the fourth conditional distribution to determine a second fidelity loss. The second fidelity loss may be determined between the third joint distribution and the fourth joint distribution based on the state of the ancilla qubit. Further, the system 102 may compute a cross fidelity wavefunction based on the first fidelity loss and the second fidelity loss, wherein the cross fidelity wavefunction is configured to further train the QNN 108.

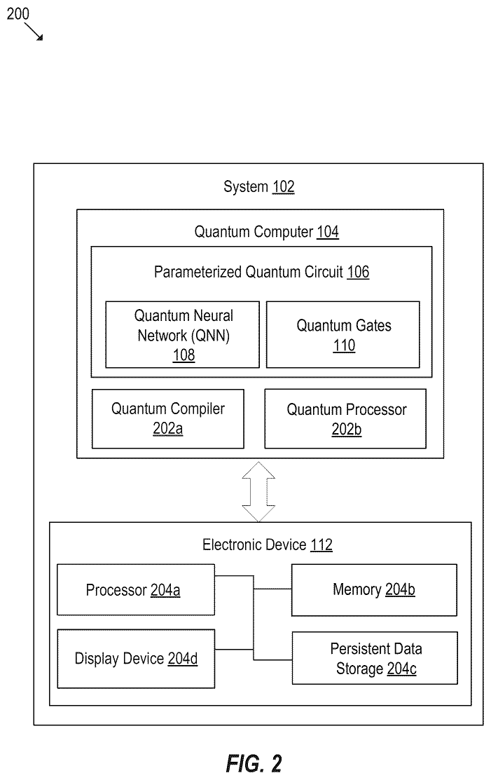

FIG. 2 is a block diagram of a system for training quantum generative networks based on marginal and joint distributions, according to at least one embodiment of the disclosure. FIG. 2 is explained in conjunction with elements from FIG. 1. With reference to FIG. 2, there is shown a block diagram 200 of the system 102. The system 102 includes the quantum computer 104 and the electronic device 112. As shown, for example, the quantum computer 104 is a gate-based quantum computer that includes the parameterized quantum circuit 106, a quantum compiler 202a, and a quantum processor 202b. Further, the parameterized quantum circuit 106 includes the Quantum Neural Network (QNN) 108, and the quantum gates 110. The electronic device 112 includes a processor 204a, a memory 204b, a persistent data storage 204c, and a display device 204d. The processor 204a and the quantum processor 202b may be referred to as one or more processors of the system 102.

Typically, a compiler is a computer program that is configured to translate computer code between two languages, i.e., source and target languages. Since quantum algorithms require error-free qubits and logic gates, the quantum compiler 202a may be configured to translate operations of the quantum gates 110 used in quantum algorithms, such as, the QAOA, into machine level operations and reduce loss of quantum information because of decoherence. A compiler for a gate-based quantum computer may perform synthesis of the quantum gates 110 at both physical and logical layers.

The quantum compiler 202a may operate on sequence of instructions (e.g., the parameterized quantum circuit 106) to ensure that such instructions are executable on the quantum computer 104. Such instructions may utilize quantum instruction sets to turn high-level algorithms into physical instructions that may be executable on the quantum processor 202b.

The quantum processor 202b (also referred to as a quantum processing unit (QPU) may refer to a physical device (e.g., a chip) that may include a set of interconnected qubits. The quantum processor 202b may typically include a housing environment (e.g., a cooling mechanism to achieve cryogenic temperature), a control system for the quantum processor 202b, and the like.

The processor 204a may include suitable logic, circuitry, and/or interfaces that may be configured to execute program instructions associated with different operations to be executed by the system 102. The processor 204a may include any suitable special-purpose or general-purpose computer, computing entity, or processing device including various computer hardware or software modules and may be configured to execute instructions stored on any applicable computer-readable storage media. For example, the processor 204a may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 2, the processor 204a may include any number of processors configured to, individually or collectively, perform or direct performance of any number of operations of the system 102, as described in the present disclosure.

In some embodiments, the processor 204a may be configured to interpret and/or execute program instructions and/or process data stored in the memory 204b and/or the persistent data storage 204c. In some embodiments, the processor 204a may fetch program instructions from the persistent data storage 204c and load the program instructions in the memory 204b. After the program instructions are loaded into memory 204b, the processor 204a may execute the program instructions. Some of the examples of the processor 204a may be a GPU, a CPU, a RISC processor, an ASIC processor, a CISC processor, a co-processor, and/or a combination thereof.

The memory 204b may include suitable logic, circuitry, and/or interfaces that may be configured to store program instructions executable by the processor 204a. In certain embodiments, the memory 204b may be configured to store the training dataset 116. The memory 204b may include computer-readable storage media for carrying or having computer-executable instructions or data structures stored thereon. Such computer-readable storage media may include any available media that may be accessed by a general-purpose or special-purpose computer, such as the processor 204a.

By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 204a to perform a certain operation or group of operations associated with the system 102.

The persistent data storage 204c may include suitable logic, circuitry, and/or interfaces that may be configured to store program instructions executable by the processor 204a, operating systems, and/or application-specific information, such as logs and application-specific databases. The persistent data storage 204c may be configured to store information, such as the set of mathematical formulations associated with the real-world optimization problem. The persistent data storage 204c may include computer-readable storage media for carrying or having computer-executable instructions or data structures stored thereon. Such computer-readable storage media may include any available media that may be accessed by a general-purpose or special-purpose computer, such as the processor 204a.

By way of example, and not limitation, such computer-readable storage media may include tangible or non-transitory computer-readable storage media including Compact Disc Read-Only Memory (CD-ROM) or other optical disk storage, magnetic disk storage or other magnetic storage devices (e.g., Hard-Disk Drive (HDD)), flash memory devices (e.g., Solid State Drive (SSD), Secure Digital (SD) card, other solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 204a to perform a certain operation or group of operations associated with the system 102.

Modifications, additions, or omissions may be made to the system 102 without departing from the scope of the present disclosure. For example, in some embodiments, the system 102 may include any number of other components that may not be explicitly illustrated or described.

The display device 204d may include suitable logic, circuitry, and interfaces that may be configured to display inputs provided by the user device 118 (and/or the host terminal 114) and outputs generated by the system 102. The display device 204d may be a touch screen which may enable a user to provide user-inputs via the display device 204d. The touch screen may be at least one of a resistive touch screen, a capacitive touch screen, or a thermal touch screen. The display device 204d may be realized through several known technologies such as, but not limited to, a Liquid Crystal Display (LCD) display, a Light Emitting Diode (LED) display, a plasma display, or an Organic LED (OLED) display technology, or other display devices. In accordance with an embodiment, the display device 204d may refer to a display screen of a head mounted device (HMD), a smart-glass device, a see-through display, a projection-based display, an electro-chromic display, or a transparent display.

Although not illustrated, the quantum computer 104 may have a hierarchical architecture with layers such as a physical layer, a virtual layer, an error correction layer, a logical layer, and an application layer. The physical layer may include hardware including, but not limited to, physical qubits and control operations. The virtual layer may incorporate error cancellation and may be responsible for collecting quantum dynamics of qubits and shaping them into virtual qubits and quantum gates. The error correction layer may incorporate quantum error correction logic for fault-tolerant quantum computing. The logical layer may support universal quantum computing by acting as a hardware-independent layer. The application layer may be a hardware independent layer that relies on logical qubits. The application layer may receive quantum algorithm as a sequence of high-level operations, including the parameterized quantum circuit 106.

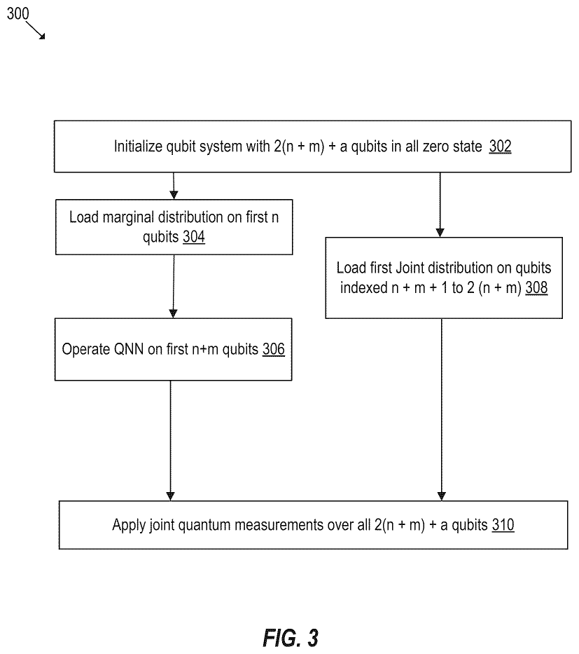

FIG. 3 is a flowchart of an example method for training with distribution loading, in accordance with an embodiment of the disclosure. FIG. 3 is explained in conjunction with elements from FIG. 1 and FIG. 2. With reference to FIG. 3, there is shown a flowchart 300 that illustrates exemplary operations, as described herein. The example method illustrated in the flowchart 300 may start at 302 and may be performed by any suitable system, apparatus, or device, such as, by the system 102 (or the electronic device 112) of FIG. 1.

At 302, the system 102 may initialize qubit system with “2(n+m)+a” qubits in all zero states. The system 102 may initialize the parameterized quantum circuit 106 on the quantum computer 104 with “2(n+m)+a” qubits in all zero states. The parameterized quantum circuit 106 may implement the QNN 108 with trainable parameters to learn the first conditional distribution of the training dataset 116 comprising the input data and the first output data.

At 304, the system 102 may load the marginal distribution on first “n” qubits (from “1” to “n” qubits), i.e., the marginal distribution may be loaded on the first set of qubits of the first set of registers. The system 102 may load the marginal distribution associated with the input data on the first set of qubits of the first set of registers of the quantum computer 104. Further, the system 102 may concatenate the first set of qubits of the first set of registers with the third set of qubits of the third set of registers to obtain a fifth set of qubits. Herein, the marginal distribution may be associated with the optimization problem on the quantum computer 104.

At 306, the system 102 may operate the QNN 108 on the “1” to “n+m” qubits, i.e., the QNN 108 may be operated on the concatenated the fifth set of qubits. The system 102 may operate the QNN 108 on the marginal distribution to predict the first conditional distribution based on the input data and the first output.

At 308, the system 102 may load the first joint distribution on the “n+m+1” to “2(n+m)” qubits, i.e., the second set of qubits of the second set of registers. The system 102 may load the first joint distribution associated with the input data and the first output data on the second set of qubits of the second set of registers of the quantum computer 104. Herein, the first joint distribution may be associated with the optimization problem on the quantum computer 104.

In an embodiment, each of the marginal distribution and the first joint distribution may be loaded on phases, amplitudes, or abstract features associated with the quantum computer 104. For example, the system 102 nay include some existing frameworks such as a Grover-Rudolph circuit (amplitude encoding), a Quantum Random Access Memory, feature maps (such ZZ maps), and learned representations such as the QNNs 108. Further, for example the QNN 108 may include quantum General Adversarial Networks, quantum convolutional networks, quantum recurrent neural networks, and the likes.

In an embodiment, the first joint distribution and the second first joint distribution may be mapped to a quantum representation “|ψ_{q}(v) [symbol] ” that may be encoded in a quantum wavefunction (like every quantum state).

In an embodiment, the system 102 may operate the QNN 108 on the marginal distribution associated with the input data and the first conditional distribution to generate the second conditional distribution associated with the input data and second output data. Further, based on the second conditional distribution, the system 102 may generate the second joint distribution. Furthermore, the system 102 may load the second joint distribution on the third set of qubits of the third set of registers of the quantum computer 104.

In an embodiment, the system 102 may apply the joint quantum measurements to measure an overlap between the first joint distribution and the second joint distribution. Further, the joint quantum measurements may be associated with a fourth set of qubits of a fourth set of registers of the quantum computer 104 as “a” ancilla qubits. Furthermore, in another embodiment, the joint quantum measurements may be associated with unitary operations and cross-qubit measurements. The cross-qubit measurements may be based on qubits on different registers of the quantum computer 104.

At 310, the system 102 may apply joint quantum measurements over all “1” to “2(n+m)+a” qubits. The system 102 may first extract the joint quantum measurements over the second joint distribution loaded on the third set of qubits of the third set of registers and the first joint distribution loaded of the second set of qubits of the second set of registers and train the QNN 108 based on the joint quantum measurements to configure the QNN 108 to learn the first conditional distribution. In another embodiment, the training of the QNN 108 may be based on multi-qubit measurements.

In an embodiment, the system 102 may prepare a particular quantum state in parallel on different set of qubits of the set of registers such that the joint quantum measurements after applying the QNN 108 may be used to update the trainable parameters with information stored on the “a” ancilla qubits.

For example, the training dataset “D” of M data points xᵢ, yᵢ, the defined joint distribution may be represented as “p(x,y)” from the frequency p(xᵢ, yᵢ), where, for an example of the frequency p(xᵢ, yᵢ), provided using equation (1), as follows:

$$p ( {x}_{i} , {y}_{i} ) = \frac{f ( {x}_{i} , {y}_{i} )}{M} \qquad ( 1 )$$

Further, the marginal distribution over Y may be provided using equation (2), as follows:

$$p ( {y}_{i} ) = \frac{f ( {y}_{i} )}{M} \qquad ( 2 )$$

Furthermore, the QNN 108 may be trained to approximately replicate the conditional distributions as provided using equation (3), as follows:

$$p ( {x}_{i} \vert {y}_{i} ) = \frac{f ( {x}_{i} , {y}_{i} )}{f ( {y}_{i} )} = \frac{p ( {x}_{i} , {y}_{i} )}{p ( {y}_{i} )} \qquad ( 3 )$$

In another embodiment, the marginal distribution, and conditional distributions may be based on auxiliary information, such as, the trainable parameters, or the known constraints. Further, the conditional distributions may not approximate the frequency perfectly. Even then, the marginal distribution “p(y)” and the joint distribution “p(x,y)” may be defined (implicitly or explicitly) to determine the conditional distribution p(x|y).

The present disclosure may address typical problems of QNN training by providing a solution to exploit quantum phenomenon in many-body systems that allow for global information extraction and accelerate the learning process and improve optimality of parameters. The present disclosure may prepare specific quantum states in parallel across different qubit registers. The quantum measurements may be taken after applying the QNN 108, and further may be utilized to update parameters using information stored on ancilla qubits. The ability of the system 102 to perform a cross-register measurements and application of control gates from ancillary qubit registers to other registers may be leveraged to enhance the method. The method may optimize the use of quantum resources and improve the efficiency of quantum computations.

The method described in the disclosure may use a wavefunction cross fidelity measures to train the QNN 108, instead of relying on a classical loss computed from classical samples post wavefunction collapse. The method may enhance a convergence quality by providing a high-quality measure over all data points at each measurement, rather than focusing on a single data point. Additionally, the method may draw parallels to the use of Bhattacharyya loss in a classical NNs, suggesting a more efficient and accurate training process for the QNN 108. Further, the method may eliminate the need for a Nash equilibrium training procedure, commonly used in quantum Generative Adversarial Networks (qGANs). The method disclosed in the present disclosure utilizes the entire marginal distributions and the joint distributions, thus resulting in a stable and faster training process, further significantly accelerating learning process of the QNN 108, and improving the accuracy.

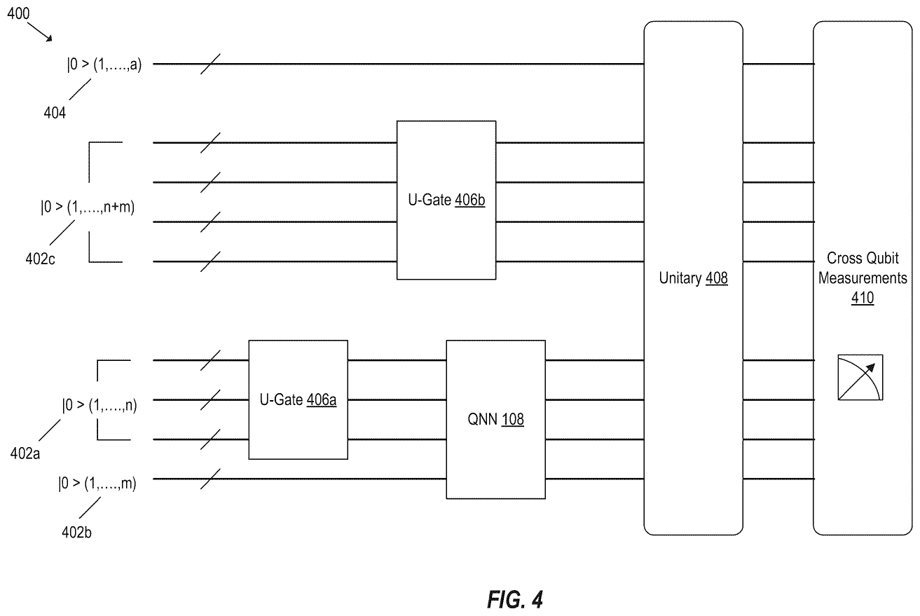

FIG. 4 is a diagram that illustrates exemplary circuit implementation for training quantum generative networks based on marginal and joint distributions, in accordance with an embodiment of the disclosure. FIG. 4 is explained in conjunction with elements from FIG. 1, FIG. 2, and FIG. 3. With reference to FIG. 4, there is shown a block diagram 400 that illustrates an exemplary circuit (for training quantum generative networks based on marginal and joint distributions) and its operations, as described herein. The exemplary operations illustrated in the block diagram 400 may be performed by any device, apparatus, or computing system, such as by the system 102 of FIG. 1.

The system 102 may initialize the parameterized quantum circuit 106 on the quantum computer 104 and further load the marginal distribution associated with the input data on the first set of qubits of the first set of registers of the quantum computer 104. For example, the first set of qubits may be represented on the “1” to “n” qubits at a state “|0 [symbol] ” on 402a in FIG. 4.

In an embodiment, for loading the marginal distribution on the first set of qubits of the first set of registers of the quantum computer 104, the system 102 may use a U-Gate 406a that may be used to generate a quantum representation of the classical distribution represented as equation (4), which follows as:

$${f}_{k} ( x ) = P r ( {X}_{k} = x ) , k = 1 , … , K . \qquad ( 4 )$$

As used herein, the term “U-Gate” refers to a multi-qubit quantum gate and in the simplest case a single-qudit quantum gate. In the case of a single qubit gate, it may perform a rotation on a Bloch sphere using three parameters, commonly referred to as Euler angles: θ, φ, and λ. The U-Gate may be denoted as “U(θ, φ, λ)”. Further, the U-Gate may be expressed as a matrix. In an embodiment, the U-Gate may be a universal gate for multi-qudit operations, which can be compiled into a sequence of single qubit (or qudit) rotations and qubit entangling gates (such as CNOTs), provided the collection is universal for quantum computation.

In an embodiment, for loading the first joint distribution on a second set of qubits of a second set of registers of the quantum computer 104, the system 102 may use a U-Gate 406b to prepare a quantum state that may be a representation of the classical distribution represented as equation (5), which follows as:

$$f ( {x}_{1} , … , {x}_{K} ) = P r ( {X}_{1} = {x}_{1} , … , {X}_{K} = {x}_{K} ) , \qquad ( 5 )$$

where, for some random variables, X₁, . . . , X_{K}, K≥2, the function is a well-defined probability distribution over discrete variables.

Next, the system 102 may generate the second joint distribution based on the second conditional distribution and load the second joint distribution on the third set of qubits of the third set of registers of the quantum computer 104. For example, the second joint distribution may be generated on the continuation qubits such as, “1” to “m” qubits in a state “|0 [symbol] ” at 402b in FIG. 4. Here, the system 102 may use the QNN 108 to generate the second joint distribution.

Further, the system 102 may operate the QNN 108 on the marginal distribution to predict the first conditional distribution and load the first joint distribution on a second set of qubits of a second set of registers of the quantum computer 104. For example, the “1” to “n+m” qubits in a state “|0 [symbol] ” at 402c in FIG. 4 may load the first joint distribution. Furthermore, the system 102 may operate the QNN 108 on the marginal distribution associated with the input data and the first conditional distribution to generate the second conditional distribution associated with the input data and second output data.

Upon the loading of the first joint distribution and the second joint distribution on the quantum computer 104, the system 102 may perform the joint quantum measurements. The joint quantum measurements may include positive-valued operator measurements 408 and cross-qubit measurements 410. Here, the joint quantum measurements may be applied over the set of qubits of the set of registers. The set of qubits of the set of registers may include the first set of qubits of the first set of registers, the second set of qubits of the second set of registers, the third set of qubits of the third set of registers, the fourth set of qubits of the fourth set of registers, and the ancilla qubits (i.e., in total qubits from “1” to “2(n+m)+a”). For example, the ancilla qubits may be used in the joint quantum measurements and further the ancilla qubits may be represented as “1” to “a” in a state “|0 [symbol] ” at 404 in FIG. 4.

Next, the system 102 may train the QNN 108 based on the joint quantum measurements. The training of the QNN 108 may configure the QNN 108 to learn the first conditional distribution of the training dataset 116. Further, in another embodiment, the system 102 may train the QNN 108 to generate the second joint distribution on the fifth set of qubits i.e., “1” to “n+m” qubits.

It should be noted that the circuit illustrated in the block diagram 400 of FIG. 4 is for exemplary purposes and should not be construed to limit the scope of the disclosure.

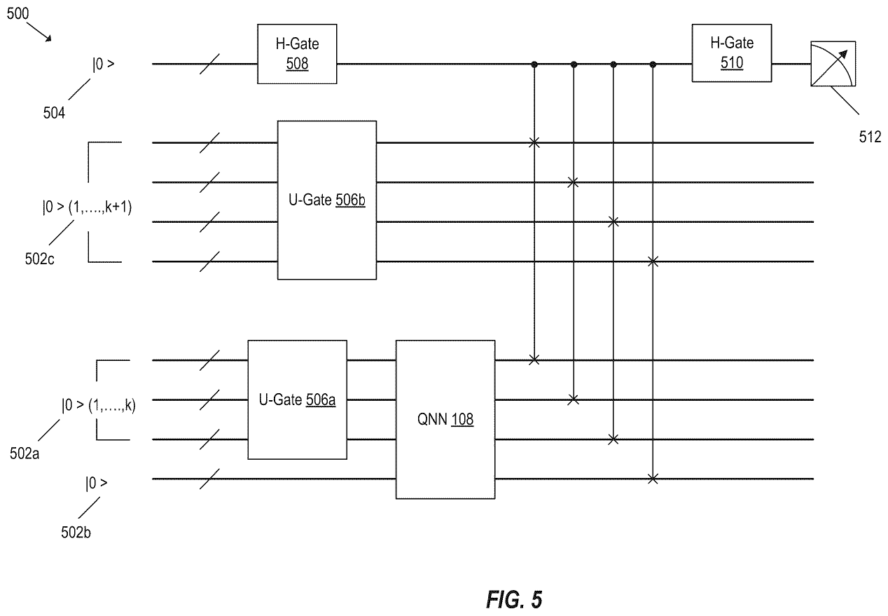

FIG. 5 is a diagram that illustrates exemplary circuit for an explicit SWAP test, according to at least one embodiment of the disclosure. FIG. 5 is explained in conjunction with elements from FIG. 1, FIG. 2, FIG. 3, and FIG. 4. With reference to FIG. 5, there is shown a block diagram 500 of an exemplary circuit (for explicit SWAP test) and its operations. The exemplary operations illustrated in the block diagram 500 may be performed by any device, apparatus, or computing system, such as, by the system 102 of FIG. 1.

Typically, a SWAP test is a quantum computing procedure that may measure a similarity between two quantum states. The swap test may determine that by how much two quantum states differ by estimating an overlap. The similarity and the difference determined by the SWAP test may be mathematically represented by the squared inner product of the states.

In context of the present disclosure, the SWAP test may be applied over the first joint distribution and the second first joint distributions to approximately measure the fidelity loss with the “a” ancilla qubit. In an exemplary embodiment, the system 102 may concatenate the first set of qubits of the first set of registers with the third set of qubits of the third set of registers to obtain a fifth set of qubits, before the application of the SWAP test.

In an embodiment, the system may determine a first fidelity loss between the first joint distribution and the second joint distribution and generate an ancilla qubit 504 in a state (for example, a state “|0 [symbol] ” or “|1 [symbol] ”) using the quantum gates 110. Further, the system 102 may swap the second set of qubits with the fifth set of qubits based on the state of the ancilla qubit 504 and operate the QNN 108 on the marginal distribution associated with the input data to generate a third conditional distribution associated with the second set of qubits and third output data. Further, the system 102 may generate a third joint distribution based on the third conditional distribution.

Next, the system 102 may operate the QNN 108 on the marginal distribution associated with the input data to generate a fourth conditional distribution associated with the fifth set of qubits and fourth output data, and further generate a fourth joint distribution based on the fourth conditional distribution.

Furthermore, the system 102 may determine a second fidelity loss between the third joint distribution and the fourth joint distribution based on the state of the ancilla qubit 504 and compute a cross fidelity wavefunction based on the first fidelity loss and the second fidelity loss. Here, the cross fidelity wavefunction may be configured to train the QNN 108.

For example, the circuit implementation in FIG. 5 may be the SWAP test over the marginal distribution and the first joint distribution or the second joint distribution. The SWAP test may measure the first fidelity loss between two quantum states, such as, “|φ [symbol] ” and “|φ [symbol] ”.

In another embodiment, the circuit implementation in FIG. 5 may be the SWAP test over the marginal distribution and the third joint distribution or the fourth joint distribution. The SWAP test may measure the second fidelity loss between two quantum states, such as, “|φ [symbol] ” and “|φ [symbol] ”. Further, the first fidelity loss or the second fidelity loss may be defined based on equation (6), as follows:

$$F ( \vert φ 〉 , \vert ϕ 〉 ) = {\vert 〈 φ \vert ϕ 〉 \vert}^{2} \qquad ( 6 )$$

where, F(|φ), |φ [symbol] )| may be the first fidelity loss or the second fidelity loss; and |φ [symbol] , |φ [symbol] are the two quantum states.

Furthermore, the fidelity loss may be a global and inherently quantum loss over both the marginal distribution and the joint distribution.

Referring to FIG. 5, an ancilla qubit 504 may be prepared in the plus state through a Hadamard (H) gate 508 or a H-Gate 510. Further, based on the logical state of the ancilla qubit 504, the system 102 may be swap the set of fifth qubits of the first set of registers and the third set of registers, such as “1” to “n+m” qubits (or “1” to “k” qubits and “1” qubit in a state “|0)”, as shown at 502a and 502b, respectively, in FIG. 5), with the second set of qubits of the second set of registers, such as “n+1” to “2(n+m)” qubits (or “1” to “k+1” in state “|0 [symbol] ”, as shown at 502c in FIG. 5). Furthermore, the phase of the ancilla qubit 504 may be used for determining the first fidelity loss or the second fidelity loss between the two quantum states. In an embodiment, the U-Gate 506a and the U-Gate 506b have similar operations as the U-Gate 406a and U-Gate 406B in FIG. 4. As used herein, the term “H-Gate” refers to a fundamental single-qubit gate in quantum computing that plays a crucial role in creating superposition states and facilitating basis transformations, known as a Hadamard gate. In context of the present discloser the H gate 508 or a H-Gate 510 may be used for preparing the ancilla qubit 504 in the plus state. Further, in an embodiment, the measurement of the first fidelity loss or the second fidelity loss may be obtained from the joint qubit measurement 512.

It should be noted that the circuit illustrated in the block diagram 500 of FIG. 5 is for exemplary purposes and should not be construed to limit the scope of the disclosure.

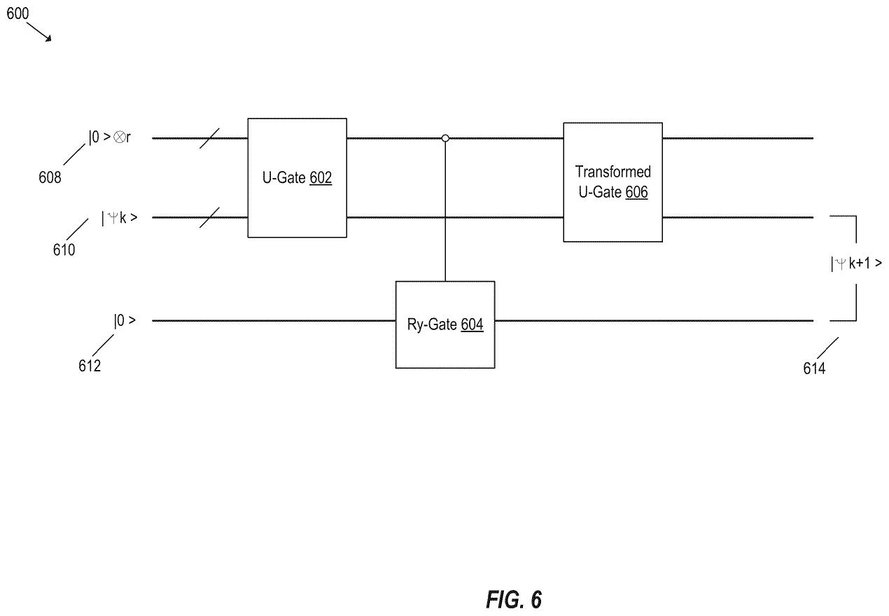

FIG. 6 is a diagram that illustrates exemplary circuit for distribution loading, according to at least one embodiment of the disclosure. FIG. 6 is explained in conjunction with elements from FIG. 1, FIG. 2, FIG. 3, FIG. 4, and FIG. 5. With reference to FIG. 6, there is shown a block diagram 600 of exemplary circuit for distribution loading and its operations. The exemplary operations illustrated in the block diagram 600 may be performed by any device, apparatus, or computing system, such as by the system 102 of FIG. 1.

Typically, distribution loading in quantum computing relates to a method of efficiently preparing and loading classical probability distributions into quantum states. The distribution loading is a critical step for the quantum computer related algorithms, more particularly in quantum machine learning and quantum simulation. Generally, the quantum computer related algorithms require an ability to represent classical data in a quantum format that may significantly enhance computational capabilities. In context of the present disclosure, the distribution loading may relate to the method for loading a marginal distribution and a joint distribution into quantum states.

In an embodiment, the marginal distribution and the joint distribution may be loaded to directly analogous representations through a Grover-Rudolph algorithm. Further, for the marginal distribution and the joint distribution loading, the system 102 may studied based on Quantum Born Machines, Quantum Boltzmann Machines, qGANs, ZZ feature maps, and amplitude loading methods.

Referring to FIG. 6, the circuit of the block diagram 600 includes a U-Gate 602, a Ry-Gate 604, a transformed U-Gate 606. Further, the circuit of the block diagram 600 includes three input/output lines. The input lines may be in a state “|0 [symbol] ”, as shown at 608, 610, and 612, in FIG. 6. Further, the output lines are shown at 614, in FIG. 6.

The U-Gate 602 may be similar to the U-Gate 406a, in FIG. 4. The Ry-Gate 604 may also be a single-qubit quantum gate used in quantum computing, for performing rotations around the Y-axis of the Bloch sphere. The Ry-Gate 604 may be used for manipulating qubit states that are represented mathematically by a unitary matrix. The transposed U-Gate 606 may refer to the transpose of a unitary gate matrix. In quantum mechanics, unitary gates may be represented by unitary matrices that may perform operations on qubits. The transposed U-Gate 606 may be obtained by transposing the unitary matrix (such as, universal gate or U-Gate 602), that may involve flipping the rows and columns of the matrix. The transposed U-Gate 606 may be denoted as U^{t}.

It should be noted that the circuit illustrated in the block diagram 600 of FIG. 6 is for exemplary purposes and should not be construed to limit the scope of the disclosure.

FIGS. 7A-7F are schematic diagrams of layered circuits structures for a quantum neural network (QNN), according to at least one embodiment of the disclosure. FIGS. 7A-7F are explained in conjunction with elements from FIG. 1, FIG. 2, FIG. 3, FIG. 4, FIG. 5, and FIG. 6. With reference to FIGS. 7A-7F, there are shown block diagrams 700A, 700B, 700C, 700D, 700E, and 700F, respectively, of exemplary layered circuit structures for the QNN 108. The training of QNNs 108 for learning the first conditional distribution or the second conditional distribution may require a different architecture than a generic QNN architecture. FIGS. 7A-7F illustrate multiple parameterized quantum circuits that may be used for developing the QNN 108 including some non-exhaustive layer constructions over few qubits such that (neural networks) NNs layers may be placed after one another to define a full circuit.

In context of the present disclosure, a Rz-Gate may also be a single-qubit quantum gate used in quantum computing, for performing rotations around the Z-axis of the Bloch sphere. The Rz-Gate may be used for manipulating qubit states that are represented mathematically by a unitary matrix. Further, a Rx-Gate may also be a single-qubit quantum gate used in quantum computing, for performing rotations around the X-axis of the Bloch sphere. The Rx-Gate may be used for manipulating qubit states that are represented mathematically by a unitary matrix.

Referring to FIG. 7A in 700A, the NNs layer that is represented may be Quantum Approximate Optimization Algorithm (QAOA)-like layer. The circuit in FIG. 7A includes a Rz-Gate 702a including a first rotation, a Rz-Gate 704a including a second rotation, a Rz-Gate 706a including a third rotation, a Rx-Gate 708a including a fourth rotation, a Rx-Gate 710a including a fifth rotation, and a Rx-Gate 712a including a sixth rotation. Further, the circuit in FIG. 7A may include three input/output lines. The input/output lines may be in a state (such as, “|0 [symbol] ” or “|1 [symbol] ”), as shown at 714a, 716a, and 718a in FIG. 7A. Furthermore, each of the Rz-Gate may be connected to an X-Gate at the input and the output side of the Rz-Gate. The X-Gate may be represented as a cross on the input and the output side of each of the Rz-Gates. For example, the cross shown at 720a-730a in FIG. 7A.

In an embodiment, the rotation associated with the quantum gates 110 may be θⱼᵢ, where θⱼᵢ may represent a first rotation to an nth rotation, and i may be “1” to “p”, where “p” is an integer. Thus, for example, the Rz-Gate 702a may include a θⱼ₁ rotation, and further may be represented as Rz(θⱼ₁). Similarly, the Rz-Gate 704a, the Rz-Gate 706a, the Rx-gate 708a, the Rx-Gate 710a, and the Rx-Gate 712a may be represented as Rz(θⱼ₂), Rz(θⱼ₃), Rx(θⱼ₄), Rx(θⱼ₅), and Rx(θⱼ₆), respectively.

For an exemplary embodiment, the QAOA-like layer may be a framework that enables efficient solutions to complex optimization problems by harnessing quantum parallelism and classical optimization strategies. The QAOA may consist of alternating layers of quantum operations, which may be referred to as QAOA-like layers.

In context of the present disclosure, an X-Gate may be a fundamental quantum gate in quantum computing that may operate on a single qubit and may be primarily used to flip the state of that qubit. Here, X-Gate may be used to performs a bit-flip operation, for example, when applied to a qubit in the state “|0 [symbol] ”, the qubit state may be transformed to “|1 [symbol] ”. Conversely, when applied to a qubit in the state “|1 [symbol] ”, the qubit state may be changed to “|0 [symbol] ”. Further in an example, the operation may be mathematically represented using a matrix form of the conventional X-Gate.

Referring to FIG. 7B in 700B, the NNs layer that is represented may be a pooling layer. The circuit in FIG. 7B includes a Rz-Gate 702b including a first rotation, a Rz-Gate 704b including a second rotation, a Ry-Gate 706b including a third rotation, and a Ry-Gate 708b including a fourth rotation. Further, the circuit in FIG. 7B may include two input/output lines. The two input/output lines may be in a state (such as, “|0 [symbol] ” or “|1 [symbol] ”), as shown at 710b and 712b, respectively, in FIG. 7B. Furthermore, the Rz-Gate 704b may be connected to an X-Gate 714b at the input side, and the Ry-Gate 708b may be connected to an X-Gate 716b at the input side. In an embodiment, the first rotation may be negative of

$$“ \frac{π}{2} ” .$$

For an exemplary embodiment, the pooling layer may be a component of quantum convolution neural networks (QCNNs) that may leverage quantum properties to efficiently manage and reduce data complexity while retaining significant information necessary for accurate computations. The pooling layer may harness the quantum computing's unique capabilities to enhance machine learning processes.

Referring to FIG. 7C in 700C, the NNs layer that is represented may be a convolution layer. The circuit in FIG. 7C includes an Rz-Gate 702c including a first rotation, a Rz-Gate 704c including a second rotation, a Ry-Gate 706c including a third rotation, a Ry-Gate 708c including a fourth rotation, and a Rz-Gate 710c including a fifth rotation. Further, the circuit in FIG. 7C includes two input/output lines. The input/output lines may be in a state (such as, “|0 [symbol] ” or “|1 [symbol] ”), as shown at 712c and 714c in FIG. 7C. Furthermore, the Rz-Gate 704c may be connected to an X-Gate 716c at the input side, the Ry-Gate 708c may be connected to an X-Gate 718c at the input side, and the Rz-Gate 710c may be connected to an X-Gate 720c at the input side. In an embodiment, the first rotation may be negative of

$$“ \frac{π}{2} ” ,$$

and the fifth rotation may be

$$“ \frac{π}{2} ” .$$

For an exemplary embodiment, the convolution layer may leverage the unique properties of quantum mechanics, such as superposition and entanglement, to enhance feature extraction from data. The convolution layer in a QCNN may be designed to extract features from the quantum states. The convolution layer may operate by applying a series of parameterized quantum gates (such as, rotation and controlled-NOT (CNOT) gates) to qubits, which may encode the input data. The operation performed may allow any network to identify patterns and relationships within the data more effectively than classical methods.

Referring to FIG. 7D in 700D, the NNs layer that is represented may be a real amplitude layer. The circuit in FIG. 7D includes an Ry-Gate 702d including a first rotation, a Ry-Gate 704d including a second rotation, a Ry-Gate 706d including a third rotation. Further, the circuit in FIG. 7D may include an X-Gate 708d connected to the output of the Ry-Gate 704d, an X-Gate 710d connected to the output of the Ry-Gate 706d, and an X-Gate 712d may be connected to the output of the Ry-Gate 702d. Further, the circuit in FIG. 7D includes three input/output lines. The input/output lines may be in a state (such as “|0 [symbol] ” or “|1 [symbol] ”), as shown at 714d, 716d and 718d, respectively, in FIG. 7D.

For an exemplary embodiment, the real amplitude layer may be a framework where quantum states may be represented using real numbers rather than complex numbers. The real amplitude layer may be relevant for the quantum computer 104 and data encoding, herein amplitudes play a crucial role in determining the behavior and outcomes of the system 102.

Referring to FIG. 7E in 700E, the NNs layer that is represented may be a quantum neuron layer. The circuit in FIG. 7E includes an R-Gate 702e including a first rotation, a Y-Gate 704e including a second rotation, an R-Gate 706e including a third rotation, and a joint quantum measurement device 714e. Further, the circuit in FIG. 7E includes three input/output lines. The input/output lines may be in a state (such as, “|0 [symbol] ” or “|1 [symbol] ”), as shown at 708e, 710e, and 712e, respectively, in FIG. 7E. Furthermore, the input side of the Y-Gate 704e may be connected to the output of the R-Gate 702e, the input side of R-Gate 706e may be connected to the output of the R-Gate 702e. In an embodiment, the third rotation may be negative the first rotation.

For an exemplary embodiment, the quantum neuron layer may include a quantum perceptron, an analogous to classical perceptron's that may be used in traditional NNs. The quantum perceptron operates on qubits (quantum bits) and may be represented as an arbitrary unitary operator that processes input qubits to produce output qubits. The number of input and output qubits may vary, allowing for flexible architectures in the quantum neural networks layer.

Referring to FIG. 7F in 700F, the NNs layer that is represented may be an efficient SU2 layer. The circuit in FIG. 7F includes an Ry-Gate 702f including a first rotation, a Ry-Gate 704f including a second rotation, a Ry-Gate 706f including a third rotation, an Rz-Gate 708f including a fourth rotation, a Rz-Gate 710f including a fifth rotation, and a Rz-Gate 712f including a sixth rotation. Further, the Ry-Gate 702f may be sequentially connected to the Rz-Gate 708f, the Ry-Gate 704f may be sequentially connected to the Rz-Gate 710f, and the Ry-Gate 706f may be sequentially connected to the Rz-Gate 712f. Furthermore, an X-Gate 714f may be connected to the output of the Rz-Gate 710f, an X-Gate 716f may be connected to the output of the Rz-Gate 712f, and an X-Gate 718f may be connected to the output of the Rz-Gate 708f. Further, the circuit in FIG. 7F may include three input/output lines. The input/output lines may be in a state (such as “|0 [symbol] ” or “|1 [symbol] ”), as shown at 720f, 722f, and 724f, respectively, in FIG. 7F.

For an exemplary embodiment, the efficient SU2 layer may be designed to implement a 2-local circuit that may consists of single-qubit operations and entanglements, which makes the circuit suitable for preparing trial wave functions in the quantum computer 104. As used herein the term “SU(2)” refers to the special unitary group of degree 2, that may consist of unitary matrices with a determinant of 1. The matrices may represent quantum gates such as Pauli rotations, crucial for manipulating qubits in the quantum computer 104. Further, the efficient SU2 layer may provide a flexible and resource-efficient way to construct the quantum computer 104 that leverages the capabilities of quantum mechanics.

For an exemplary embodiment, the efficient SU2 layer may be designed to implement a 2-local circuit that may consists of single-qubit operations and entanglements, which makes the circuit suitable for preparing trial wave functions in the quantum computer 104. As used herein the term “SU(2)” refers to the special unitary group of degree 2, that may consist of unitary matrices with a determinant of 1. The matrices may represent quantum gates such as Pauli rotations, crucial for manipulating qubits in the quantum computer 104. Further, the efficient SU2 layer may provide a flexible and resource-efficient way to construct the quantum computer 104 that leverages the capabilities of quantum mechanics.

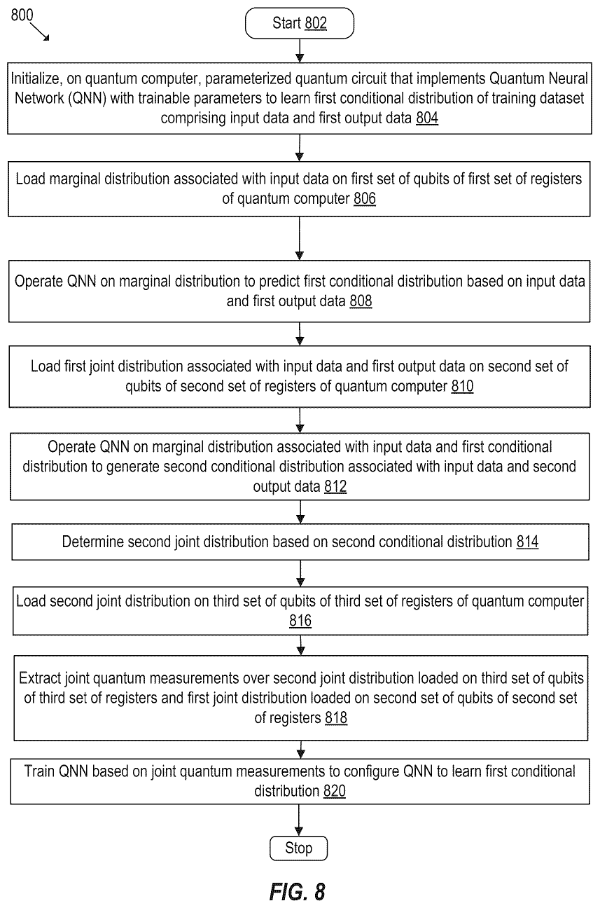

FIG. 8 is a flowchart of an example method for training quantum generative networks based on marginal and joint distributions, arranged in accordance with at least one embodiment described in the present disclosure. FIG. 8 is explained in conjunction with elements from FIG. 1, FIG. 2, FIG. 3, FIG. 4, FIG. 5, FIG. 6, and FIGS. 7A-7F. With reference to FIG. 8, there is shown a flowchart 800. The example method illustrated in the flowchart 800 may be performed by any suitable system, apparatus, or device, such as by the system 102 of FIG. 1. The flowchart 800 may start at 802 and proceed to 804.

At 804, the parameterized quantum circuit 106 may be initialized on the quantum computer 104. The system 102 may initialize, on the quantum computer 104, the parameterized quantum circuit 106 to implement the QNN 108 with trainable parameters. In accordance with an embodiment, the QNN 108 with trainable parameters may be implemented to learn a first conditional distribution of a training dataset. In accordance with an embodiment, the training dataset comprises input data and a first output data. The initialization of the parameterized quantum circuit is described further, for example, in FIG. 3 and FIG. 4.

At 806, a marginal distribution may be loaded. The system 102 may load the marginal distribution associated with the input data on a first set of qubits of a first set of registers of the quantum computer 104. In accordance with an embodiment, the marginal distribution may be associated with an optimization problem on the quantum computer 104. The loading of the marginal distribution is described further, for example, in FIG. 3 and FIG. 4.

At 808, the first conditional distribution may be predicted. The system 102 may operate the QNN 108 on the marginal distribution to predict the first conditional distribution based on the input data and the first output. The prediction of the first conditional distribution, based on the operation of the QNN, is described further, for example, in FIG. 3 and FIG. 4.

At 810, a first joint distribution may be loaded. The system 102 may load the first joint distribution associated with the input data and the first output data on a second set of qubits of a second set of registers of the quantum computer 104. In accordance with an embodiment, the first joint distribution may be associated with an optimization problem on the quantum computer 104. In accordance with an embodiment, the first joint distribution may be loaded on phases, amplitudes, or abstract features associated with the quantum computer 104. The loading of the first joint distribution is described further, for example, in FIG. 3 and FIG. 4.

At 812, a second conditional distribution may be generated. The system 102 may operate the QNN 108 on the marginal distribution associated with the input data and the first conditional distribution to generate the second conditional distribution associated with the input data and second output data. The generation of the second conditional distribution, based on the operation of the QNN, is described further, for example, in FIG. 3 and FIG. 4.

At 814, a second joint distribution may be generated. The system 102 may generating the second joint distribution based on the second conditional distribution. The generation of the second joint distribution is described further, for example, in FIG. 3 and FIG. 4.

At 816, the second joint distribution may be loaded. The system 102 may load the second joint distribution on a third set of qubits of a third set of registers of the quantum computer 104. The loading of the second joint distribution is described further, for example, in FIG. 3 and FIG. 4.

At 818, joint quantum measurements may be extracted. The system 102 may extract joint quantum measurements over the second joint distribution loaded on the third set of qubits of the third set of registers and the first joint distribution loaded of the second set of qubits of the second set of registers. In accordance with an embodiment, the joint quantum measurements are applied to measure an overlap between the first joint distribution and the second joint distribution.

In accordance with an embodiment, the joint quantum measurements may be associated with a fourth set of qubits of a fourth set of registers of the quantum computer 104 as ancilla qubits. In accordance with an embodiment, the joint quantum measurements may be associated with positive-valued operator measurements and cross-qubit measurements. Further, the cross-qubit measurements may be based on qubits on different registers of the quantum computer 104. The extraction of the joint quantum measurements is described further, for example, in FIG. 3 and FIG. 4.

At 820, the QNN 108 may be trained. The system 102 may train the QNN 108 based on the joint quantum measurements to configure the QNN 108 to learn the first conditional distribution. In accordance with an embodiment, the training of the QNN 108 is based on multi-qubit measurements. The training of the QNN is described further, for example, in FIG. 3, FIG. 4, FIG. 5, and FIG. 6. Control may pass to end.

Although the flowchart 800 is illustrated as discrete operations, such as 802, 804, 806, 808, 810, 812, 814, 816, 818, and 820; however, in certain embodiments, such discrete operations may be further divided into additional operations, combined into fewer operations, or eliminated, depending on the particular implementation.

Various embodiments of the disclosure may provide a non-transitory computer-readable storage medium configured to store instructions that, in response to being executed, causes a system (such as the system 102) to perform operations that include initializing, on a quantum computer, a parameterized quantum circuit that implements a Quantum Neural Network (QNN) with trainable parameters to learn a first conditional distribution of a training dataset comprising input data and a first output data. The operations further include loading a marginal distribution associated with the input data on a first set of qubits of a first set of registers of the quantum computer. The operations further include operating the QNN on the marginal distribution to predict the first conditional distribution based on the input data and the first output. The operations further include loading a first joint distribution associated with the input data and the first output data on a second set of qubits of a second set of registers of the quantum computer. The operations further include operating the QNN on the marginal distribution associated with the input data and the first conditional distribution to generate a second conditional distribution associated with the input data and second output data. The operations further include generating a second joint distribution based on the second conditional distribution. The operations further include loading the second joint distribution on a third set of qubits of a third set of registers of the quantum computer. The operations further include extracting joint quantum measurements over the second joint distribution loaded on the third set of qubits of the third set of registers and the first joint distribution loaded of the second set of qubits of the second set of registers. The operations further include training the QNN based on the joint quantum measurements to configure the QNN to learn the first conditional distribution.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, executed by a processor, the method comprising:
initializing, on a quantum computer, a parameterized quantum circuit that implements a Quantum Neural Network (QNN) with trainable parameters to learn a first conditional distribution of a training dataset comprising input data and a first output data;
loading a marginal distribution associated with the input data on a first set of qubits of a first set of registers of the quantum computer;
operating the QNN on the marginal distribution to predict the first conditional distribution based on the input data and the first output;
loading a first joint distribution associated with the input data and the first output data on a second set of qubits of a second set of registers of the quantum computer;
operating the QNN on the marginal distribution associated with the input data and the first conditional distribution to generate a second conditional distribution associated with the input data and second output data;
generating a second joint distribution based on the second conditional distribution;
loading the second joint distribution on a third set of qubits of a third set of registers of the quantum computer;
extracting joint quantum measurements over the second joint distribution loaded on the third set of qubits of the third set of registers and the first joint distribution loaded of the second set of qubits of the second set of registers; and
training the QNN based on the joint quantum measurements to configure the QNN to learn the first conditional distribution.

2. The method according to claim 1, wherein the marginal distribution and the first joint distribution are associated with an optimization problem on the quantum computer.

3. The method according to claim 1, wherein each of the marginal distribution and the first joint distribution is loaded on phases, amplitudes, or abstract features associated with the quantum computer.

4. The method according to claim 1, wherein the training of the QNN is based on multi-qubit measurements.

5. The method according to claim 1, wherein the joint quantum measurements are applied to measure an overlap between the first joint distribution and the second joint distribution.

6. The method according to claim 1, wherein the joint quantum measurements are associated with a fourth set of qubits of a fourth set of registers of the quantum computer as ancilla qubits.

7. The method according to claim 1, wherein the joint quantum measurements are associated with unitary measurements and cross-qubit measurements.

8. The method according to claim 7, wherein the cross-qubit measurements are based on qubits on different registers of the quantum computer.

9. The method according to claim 1, further comprising concatenating the first set of qubits of the first set of registers with the third set of qubits of the third set of registers to obtain a fifth set of qubits.

10. The method according to claim 9, further comprising:
determining a first fidelity loss between the first joint distribution and the second joint distribution;
generating an ancilla qubit in a state using a quantum gate;
swapping the second set of qubits with the fifth set of qubits based on the state of the ancilla qubit;
operating the QNN on the marginal distribution associated with the input data to generate a third conditional distribution associated with the second set of qubits and third output data;
generating a third joint distribution based on the third conditional distribution;
operating the QNN on the marginal distribution associated with the input data to generate a fourth conditional distribution associated with the fifth set of qubits and fourth output data;
generating a fourth joint distribution based on the fourth conditional distribution;
determining a second fidelity loss between the third joint distribution and the fourth joint distribution based on the state of the ancilla qubit; and
computing a cross fidelity wavefunction based on the first fidelity loss and the second fidelity loss, wherein
the cross fidelity wavefunction is configured to train the QNN.

11. The method according to claim 1, wherein the quantum computer corresponds to at least one of: quantum processors, digital quantum computers, quantum computers based on microwave-pulses acting on superconducting devices, or quantum computers based on laser pulses acting on ion-trap devices.

12. A non-transitory computer-readable storage medium configured to store instructions that, in response to being executed, causes a system to perform operations, the operations comprising:
initializing, on a quantum computer, a parameterized quantum circuit that implements a Quantum Neural Network (QNN) with trainable parameters to learn a first conditional distribution of a training dataset comprising input data and a first output data;
loading a marginal distribution associated with the input data on a first set of qubits of a first set of registers of the quantum computer;
operating the QNN on the marginal distribution to predict the first conditional distribution based on the input data and the first output;
loading a first joint distribution associated with the input data and the first output data on a second set of qubits of a second set of registers of the quantum computer;
operating the QNN on the marginal distribution associated with the input data and the first conditional distribution to generate a second conditional distribution associated with the input data and second output data;
generating a second joint distribution based on the second conditional distribution;
loading the second joint distribution on a third set of qubits of a third set of registers of the quantum computer;
extracting joint quantum measurements over the second joint distribution loaded on the third set of qubits of the third set of registers and the first joint distribution loaded of the second set of qubits of the second set of registers; and
training the QNN based on the joint quantum measurements to configure the QNN to learn the first conditional distribution.

13. The non-transitory computer-readable storage medium according to claim 12, wherein each of the marginal distribution and the first joint distribution is loaded on phases, amplitudes, or abstract features associated with the quantum computer.

14. The non-transitory computer-readable storage medium according to claim 12, wherein the training of the QNN is based on multi-qubit measurements.

15. The non-transitory computer-readable storage medium according to claim 12, wherein the joint quantum measurements are applied to measure an overlap between the first joint distribution and the second joint distribution.

16. The non-transitory computer-readable storage medium according to claim 12, wherein the joint quantum measurements are associated with a fourth set of qubits of a fourth set of registers of the quantum computer as an ancilla qubits.

17. The non-transitory computer-readable storage medium according to claim 12, wherein the joint quantum measurements are associated with unitary measurements and cross-qubit measurements.

18. The non-transitory computer-readable storage medium according to claim 12, further comprising concatenating the first set of qubits of the first set of registers with the third set of qubits of the third set of registers to obtain a fifth set of qubits.

19. The non-transitory computer-readable storage medium according to claim 18, further comprising:
determining a first fidelity loss between the first joint distribution and the second joint distribution;
generating an ancilla qubit in a state using a quantum gate;
swapping the second set of qubits with the fifth set of qubits based on the state of the ancilla qubit;
operating the QNN on the marginal distribution associated with the input data to generate a third conditional distribution associated with the second set of qubits and third output data;
generating a third joint distribution based on the third conditional distribution;
operating the QNN on the marginal distribution associated with the input data to generate a fourth conditional distribution associated with the fifth set of qubits and fourth output data;
generating a fourth joint distribution based on the fourth conditional distribution;
determining a second fidelity loss between the third joint distribution and the fourth joint distribution based on the state of the ancilla qubit; and
computing a cross fidelity wavefunction based on the first fidelity loss and the second fidelity loss, wherein
the cross fidelity wavefunction is configured to train the QNN.

20. An electronic device, comprising:
a memory configured to store instructions; and
a processor, coupled to the memory, configured to execute the instructions to perform a process comprising:
initializing, on a quantum computer, a parameterized quantum circuit that implements a Quantum Neural Network (QNN) with trainable parameters to learn a first conditional distribution of a training dataset comprising input data and a first output data;
loading a marginal distribution associated with the input data on a first set of qubits of a first set of registers of the quantum computer;
operating the QNN on the marginal distribution to predict the first conditional distribution based on the input data and the first output;
loading a first joint distribution associated with the input data and the first output data on a second set of qubits of a second set of registers of the quantum computer;
operating the QNN on the marginal distribution associated with the input data and the first conditional distribution to generate a second conditional distribution associated with the input data and second output data;
generating a second joint distribution based on the second conditional distribution;
loading the second joint distribution on a third set of qubits of a third set of registers of the quantum computer;
extracting joint quantum measurements over the second joint distribution loaded on the third set of qubits of the third set of registers and the first joint distribution loaded of the second set of qubits of the second set of registers; and
training the QNN based on the joint quantum measurements to configure the QNN to learn the first conditional distribution.
